(19) United States
(12) Patent Application Publication
(10) Pub. No.: US 2005/0136905 A1
(43) Pub. Date: Jun. 23, 2005

(54) Apparatus for automatically connecting devices according to user's preference and method thereof

(76) Inventors: JiYeon Son, Daejon (KR); Jun-Seok Park, Daejon (KR); Myunggyu Kim, Daejon (KR); Dong-Won Han, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/831,066

(22) Filed: Apr. 22, 2004

(30) Foreign Application Priority Data
Dec. 17, 2003 (KR) 2003-92637

(51) Int. Cl. H04M 3/00

(52) U.S. Cl. 455/418; 455/419

(57) ABSTRACT

An apparatus and a method for automatically connecting devices according to user's preference are disclosed. The apparatus includes a service selection condition setting unit for converting service selection condition according to user's preference to service selection condition data; a service selection condition storing unit for storing the service selection condition data; a service discovery unit for collecting a service discovery data from service providing devices according to a service discovery request, and connecting devices automatically according to service selection data; and a service matching unit for selecting a service to be connected based on the service selection condition data extracted from the service selection condition storing unit in response to a service selection request from the service discovery unit, and for generating and transferring to the service discovery unit the service selection data indicating the selected service.

### FIELD OF THE INVENTION

The present invention relates to an apparatus for connecting devices automatically according to user's preference and a method thereof.

### DESCRIPTION OF RELATED ART

Recently, communicational electric home appliances are digitalized rapidly as computer system and peripheral devices are portable and miniaturized. In other word, not only a laptop computer and more miniaturized communication devices, e.g., a smart phone, a personal digital assistance (PDA) and a wireless telecommunication terminal, but also electric home appliances, e.g., an audio system, a camera, a set top box, an electric refrigerator, TV, etc. are getting digitalized. Because of digitalization of communication devices and communicational electric home appliances, it is needed a communication method for recognizing and controlling of the devices connected through the wired/wireless network whenever and wherever.

Under the necessity as mentioned, various standard service discovery protocols have been suggested.

At first, Universal Plug and Play (UPnP) forum suggested “UPnP” as a part of network plug and play. “UPnP” is a networking based protocol and defines its structure using a protocol widely used in the Internet as Transmission Control Protocol (TCP), User Datagram Protocol (UDP), Hyper Text Transfer Protocol (HTTP), extensible Markup Language (XML), etc. The purposes of “UPnP” are a construction of seamless network among devices using various media in the home networking and a change of the network without effort of a user or an administrator whenever each device is added or deleted to the network.

“UPnP” includes a control point and a device. The control point requests services to the device, and the device provides the required service to the control point. At this time, the services provided by “UPnP” are described based on XML including not only models, manufacturer information but also operations, parameters and variables, etc. of the service.

Hereinafter, a service means an operation provided and performed by a node. The service is classified into two levels. One is an application level and the other is a platform level. The former could provide a service of program, data, storage, etc. The letter could provide a service of node, node group, pipe (data channel among nodes), etc.

Bluetooth Special Interest Group (SIG) suggested a service Discovery Protocol (SDP) as a protocol for discovering Bluetooth devices. The Service Discovery Protocol (SDP) is a communication method between server and client based on exchange of (request/reply) message, and provides searching function by service class or service property and browsing function. The service is described as a service class and a service record. The service class includes a device category (e.g., a printer and storage device) for classifying services. The service record includes a named of model, protocols supported by the service and property of the service. The SDP includes functions discovering a new service when a client device approaches to an available range, and recognizing that a device is no more serviced when the client device is out of an available range.

On one side, “Internet Engineering Task Force (IETF)” suggested a Service Location Protocol (SLP) based on RFC2608 specification. A communication model of SLP includes a User Agent (UA), a Service agent (SA) and a Directory Agent (DA). The DA could be omitted.

There are several standard service discovery protocols, a “Jini” suggested by Sun Microsystems and “Salutation” suggested by Salutation consortium.

However, the above-mentioned service discovery methods have certain drawbacks in that correlation with the user is necessary to discovery and control the service when the several services are related to each other in the network.

For example, if a user wants to get a video service using unfamilar network in a new place, the user must have vexatious process to choose each device, e.g., a media server, a speaker, a display device, an amplifier, etc. and connect each by each.

Therefore, it is strongly required a method for automatically recognizing and controlling a service, which allows user to set up available devices located at a short distance as a network and use the service easily.

### SUMMARY OF THE INVENTION

It is, therefore, an object of the present invention to provide an apparatus for automatically connecting devices according to user's preference satisfying the pre-set selection condition among devices discovered by a service requesting device based on a service discovery protocol in wired/wireless network recognizing a service by the service discovery protocol and a method thereof.

In accordance with an aspect of the present invention, there is provided an apparatus for automatically connecting devices according to user's preference, including: a service selection condition setting unit for converting service selection condition according to user's preference to service selection condition data; a service selection condition storing unit for storing the service selection condition data; a service discovery unit for collecting a service discovery data from service providing devices according to a service discovery request, and connecting devices automatically according to service selection data; and a service matching unit for selecting a service to be connected based on the service selection condition data extracted from the service selection condition storing unit in response to a service selection request from the service discovery unit, and for generating and transferring to the service discovery unit the service selection data indicating the selected service.

In accordance with another aspect of the present invention, there is provided a method for automatically connecting devices according to user's preference, including the steps of: a) at a service selection condition setting block, converting service selection condition according to user's preference to service selection condition data; b) at a service discovery block, collecting the service discovery data from service providing devices according to the service discovery request, and requesting the service selection to the service matching block by transferring the service discovery data collected from service providing devices; c) at a service matching block, selecting a service for automatically connecting devices based on the service selection condition data extracted from the service selection condition storing block in response to the service selection request from the service discovery block, and generating and transferring the service selection data to the service discovery block; and d) the service discovery block, automatically connecting the service requesting device to the providing device according to the service selection data of the service matching block.

### BRIEF DESCRIPTION OF THE DRAWINGS

The above and other objects and features of the present invention will become apparent from the following description of the preferred embodiments given in conjunction with the accompanying drawings, in which:

FIG. 1 is a diagram showing a wire/wireless network to which an embodiment of the present invention is applied;

FIG. 2 is a block diagram describing an apparatus for automatically connecting devices according to user's preference (hereinafter, which is also referred to an auto connecting apparatus) in accordance with an embodiment of the present invention;

FIG. 3 is a flowchart illustrating a method for automatically connecting devices according to user's preference in accordance with an embodiment of the present invention;

FIG. 4 is a detailed flowchart showing the service matching process of the method for connecting devices automatically according to user's preference in accordance with the embodiment of the present invention; and

FIG. 5 is a diagram showing service selection condition data in accordance with an embodiment of the present invention.

### DETAILED DESCRIPTION OF THE INVENTION

Other objects and aspects of the invention will become apparent from the following description of the embodiments with reference to the accompanying drawings, which is set forth hereinafter.

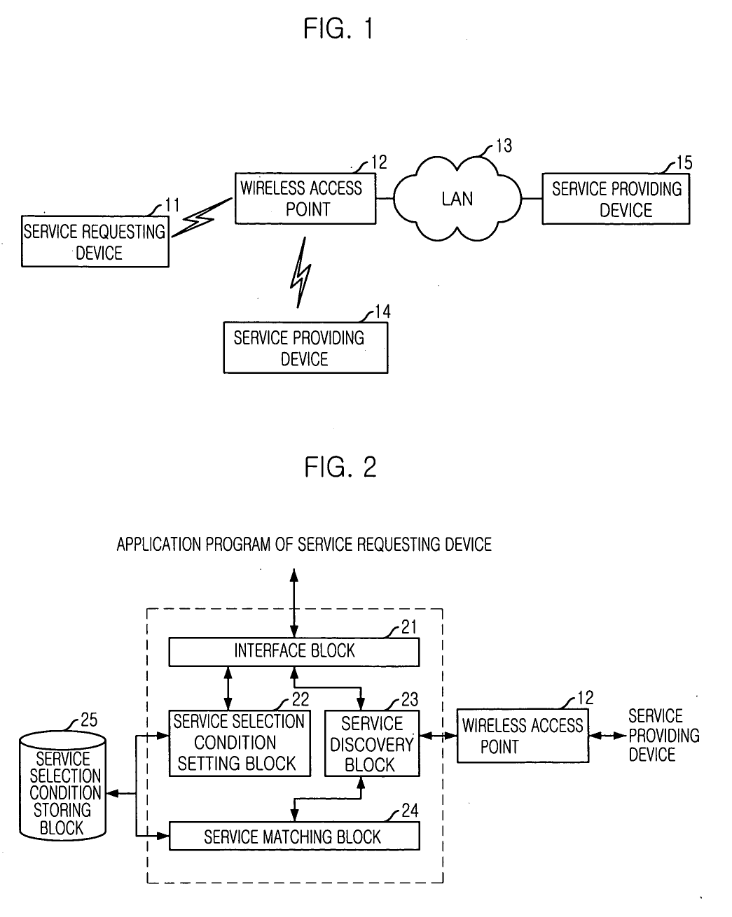

FIG. 1 is a diagram showing a wire/wireless network, to which an embodiment of the present invention is applied.

As shown, the wire/wireless network includes a service requesting device 11, an access point 12, service providing devices 14, 15 and a Local Area Network (LAN) 13 for providing a wire/wireless interface among the devices. The service requesting device 11 is connected to the access point 12 and sets up a connection, to the service providing device 14 in a close distance and/or a connection to the service providing device 15 through the LAN 13. The communication method between the service requesting device 11 and service providing devices 14, 15 may be any one of published standard device discovery protocols and communication protocols, e.g., “UPnP”, “SLP”, “Jini” and “Salutation” developed independently. However the same protocol should be used between the service requesting device 11 and the service providing devices 14, 15.

FIG. 2 is a block diagram describing an apparatus for automatically connecting devices according to user's preference (hereinafter, which is also referred as an auto connecting apparatus) in accordance with an embodiment of the present invention.

As shown, the auto connecting apparatus includes an interface block 21, a service selection setting block 22, a service discovery block 23, a service matching block 24 and a service selection condition storing block 25. The interface block 21 transfers a service selection condition received from a user by an application program to the service selection setting block 22, and transfers a service discovery request received from the user through the application program to the service discovery block 23 for automatically connecting devices. The service selection condition setting block 22 transforms the service selection condition from the interface block 21 into standard service selection condition data to be stored at service selection condition storing block 25. The service discovery block 23 collects a service discovery data from the service providing device 14, 15 according to the service discovery request from the interface block 21, and requests the service matching block 24 to select a service with the collected data, and automatically connects devices according to the returned service selection data. The service matching block 24 extracts service selection condition data stored at the service selection condition storing block 25 in response to the service selection request received from the service discovery block 23, and selects a service to connect automatically according to whether the service discovery data of the service discovery block 23 is equal to the service selection condition data extracted from the service selection condition storing block 25 or not, and transfers the service selection condition data to the service discovery block 23. The service selection condition storing block 25 stores the service selection condition data in accordance with a control signal from the service selection condition setting block 22.

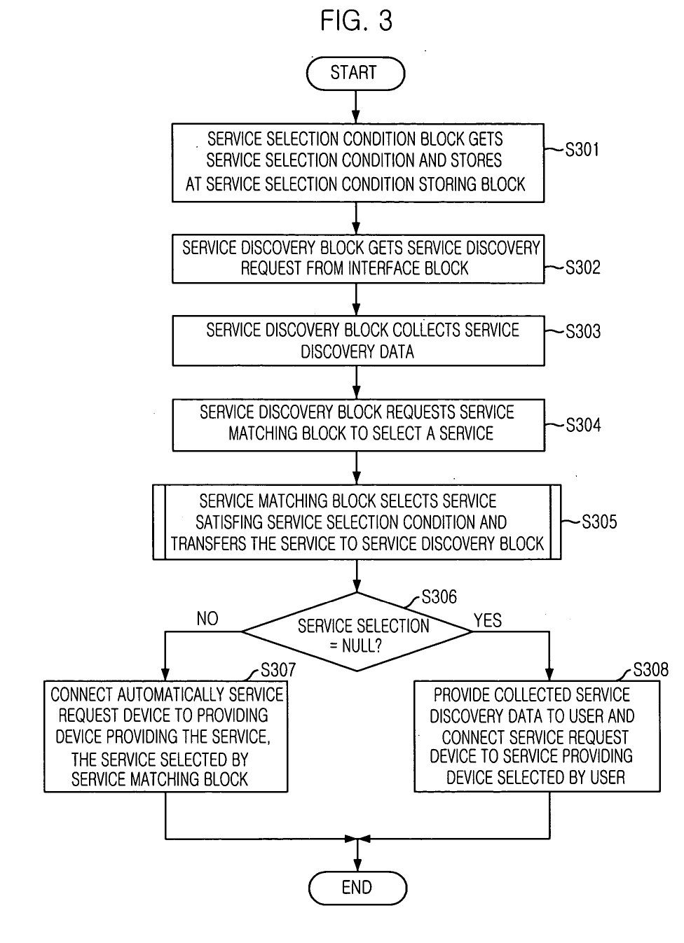

The application programs executed by the interface block 21 includes a program for managing general operation of devices and/or a program for operating a service discovery protocol. The application program can be executed by the service discovery block 23 and the service selection condition setting block 22 in this case of the interface block 21 is not needed. The entire operation of the auto connecting apparatus will be described, herein, referring to FIG. 3.

FIG. 3 is a flowchart illustrating the method for automatically connecting devices according to user's preference (hereinafter, which is referred as an auto connecting method) in accordance with an embodiment of the present invention.

At first, the service selection condition setting block 22 transforms the service selection condition received from the interface block 21 into standard service selection condition data, and stores the service selection condition data at the service selection condition storing block 25 at step of S301. The service selection condition data includes, referring to FIG. 5, a user criterion list 51 and a service criterion list 52. The user criterion list 51 includes service discovery data which are a criterion, a name, a permitted value and a keyword, of the service selection condition set by the user. The service criterion list 52 includes a selection criterion data, which are priority, a name, a conditional expression and an item, set by the user according to service types.

Referring to the user criterion list 51, the criterion field represents a factor of criterions. The name field represents a name of a criterion in a letter form. The keyword field represents a keyword in a letter form for searching the criterion. In particular, the name field is used in the service selection criterion list 52.

At step S302, the service discovery block 23 gets the service discovery request from the interface block 21, the interface block 21 collects service discovery data by transferring the service discovery request to service providing devices 14, 15, and transfers the collected service discovery data to the service matching block 24, and requests the service matching block 24 to select the service. Wherein, the service discovery data collected by the service providing devices 14, 15 include manufacture information, model names, serial numbers, service types, used commands and parameter information.

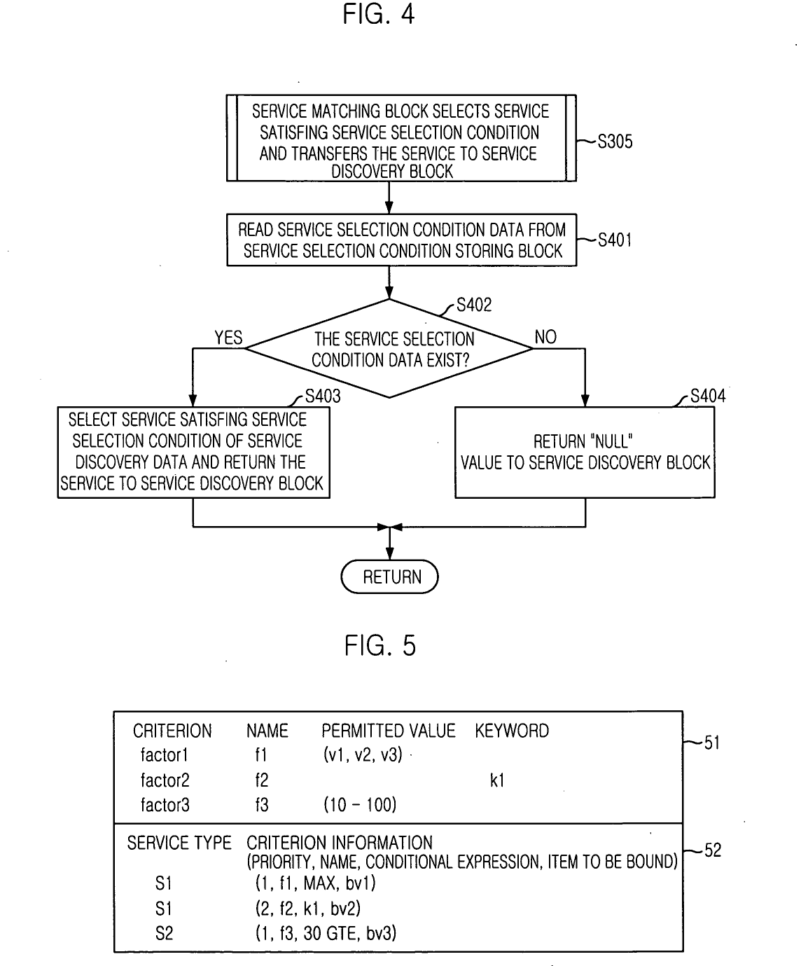

Then, at step S305, the service matching block 24 extracts the service selection condition data from the service selection condition storing block 25, and selects the service to be connected, which satisfies the extracted service selection condition data, and returns the data including the selected service to the service discovery block 23. If there is no service selection condition data corresponding to the service discovery data, or the service discovery data does not matched to the service selection condition data, the service selection data is “NULL”. The detailed process will be described, with reference to FIG. 4 in detail.

Then, at step S306, the service discovery block 23 checks whether the service selection data of the service matching block 23 is “NULL” or not. If the service selection data is “NULL”, the service discovery data from the service providing devices 14, 15 provided to the user to select one of the services, and the selected service providing device is connected as the conventional method. If not, the selected service providing device 14, 15 is automatically connected.

FIG. 4 is a detailed flowchart showing the service matching process of the auto connecting method in accordance with an embodiment of the present invention.

At step S401, the service matching block 24 reads the service selection condition data from the service selection condition storing block 25, and at step S402, checks whether the service selection condition data correspond to the service discovery data of the service discovery block 23 exist or not.

As the result of the step S402, at step S403, if there is the service selection condition data corresponding to the service discovery data, the service matching block 24 selects one of the services each of which the service discovery data satisfies the service selection condition data according to the priority of the service, and then returns the service selection data to the service discovery block 23.

As the result of the check at step S402, if there is not the service selection condition data correspond to the service discovery data, the service matching block 24 returns “NULL” to the service discovery block 23.

As above-mentioned, the method of the present invention can be embodied as a program and stored in recording media readable by a computer, e.g., CD-ROM, RAM, floppy disk, hard disk, magneto-optical disk, etc. The process of the above-mentioned could be executed by those skilled in the art. Further description on it will not be provided herein.

The effect of the present invention as recited in the above is briefly summarized herein in such a way that an auto connecting apparatus of the present invention improves the convenience of user exceedingly by automatically connecting devices satisfying the service selection condition data to one of devices discovered by a service requesting device 11 based on a service discovery protocol in wired/wireless network recognizing a service by the service discovery protocol, e.g., “UPnP”, “SDP”, “Jini” and “salutation”, etc.

The present application contains subject matter related to Korean paten application no. 2003-79003, filed in the Korean Patent Office on Nov. 10, 2003, the entire contents of which being incorporated herein by reference.

While the present invention has been described with respect to certain preferred embodiments, it will be apparent to those skilled in the art that various changes and modifications may be made without departing from the scope of the invention as defined in the following claims.

1. An apparatus for automatically connecting devices according to user's preference, comprising:
a service selection condition setting means for converting service selection condition according to user's preference to service selection condition data;
a service selection condition storing means for storing the service selection condition data;
a service discovery means for collecting a service discovery data from service providing devices according to a service discovery request, and connecting devices automatically according to service selection data; and
a service matching means for selecting a service to be connected based on the service selection condition data extracted from the service selection condition storing means in response to a service selection request from the service discovery means, and for generating and transferring to the service discovery means the service selection data indicating the selected service.

2. The apparatus as recited in claim 1, wherein the service selection condition setting means transforms the service selection condition inputted by a user into standard service selection condition data, and controls the service selection condition data to be stored at the service selection condition storing means.

3. The apparatus as recited in claim 1, wherein the service matching means reads the service selection condition data from the service selection condition storing means according to the service selection request from the service discovery means, determines whether a service satisfying the service selection condition data exists or not in the service discovery data transferred from the service discovery means, selects one of the services satisfying the service selection condition data based on priority, and transfers the service selection data indicating the service to the service discovery means.

4. The apparatus as recited in claim 3, wherein, if there is no service selection data of the service matching means, the collected data from the service providing device are provided to the user so that the user selects the service to be connected, and if there is the service selection data, the service providing device corresponding the service is controlled to be connected.

5. A method for automatically connecting devices according to user's preference, comprising the steps of:
a) at a service selection condition setting block, converting service selection condition according to user's preference to service selection condition data;
b) at a service discovery block, collecting the service discovery data from service providing devices according to the service discovery request, and requesting the service selection to the service matching block by transferring the service discovery data collected from service providing devices;
c) at a service matching block, selecting a service for automatically connecting devices based on the service selection condition data extracted from the service selection condition storing block in response to the service selection request from the service discovery block, and generating and transferring the service selection data to the service discovery block; and
d) the service discovery block, automatically connecting the service request device to the providing device according to the service selection data of the service matching block.

6. The method as recited in claim 5, wherein the step a) includes the steps of:
a1) at the service selection condition setting block, transforming the service selection condition inputted by the user into the standard service selection condition data, and controlling the service selection condition data to be stored at the service selection condition storing block.

7. The method as recited in claim 5, where the step c) includes the steps of:
c1) at the service matching block, reading the service selection condition data from the service selection condition storing block in response to the service selected request from the service discovery block; and
c2) at the service matching block, determining whether the service satisfying the service selection condition exists or not in the service discovery data transferred from the service discovery block, and selecting one of the services satisfying the service selection condition data based on priority, and transferring the service selection data indicating the service to the service discovery block.

8. The method as recited in claim 5, where the step d) includes the steps of:
d1) at the service discovery block, checking whether the service selection data of the service matching block is NULL or not;
d2) if there is the service selection data of the service matching block, connecting the service providing device corresponding to the service; and
d3) if there is no service selection data of the service matching block, providing the collected data from the service providing device to the user, so that the user selects the service to be connected.
